(19) United States
(12) Patent Application Publication
(10) Pub. No.: US 2011/0096822 A1
(43) Pub. Date: Apr. 28, 2011

(54) NETWORK EQUIPMENT

(76) Inventor: Junya Senoo, Daito-shi (JP)

(21) Appl. No.: 12/910,298

(22) Filed: Oct. 22, 2010

(30) Foreign Application Priority Data
Oct. 23, 2009 (JP) 2009-244944

(51) Int. Cl. H04B 17/00

(52) U.S. Cl. 375/225

(57) ABSTRACT

A network player is connected to a server, in which a contents data having a bit rate parameter is recorded, via a network. The network player stores the contents data which is currently received from the server in a buffer memory, measures a data transfer rate of the currently received contents data based on an increase and decrease of the data amount stored in the buffer memory, and repeats the measurement until a predetermined period of time passes. After the predetermined period of time, the network player determines the current data transfer rate by calculating an average value of the plural data transfer rates measured in the predetermined period of time. Then, the network player informs that the data transfer rate is not fast enough by turning on a red lamp when the current data transfer rate is slower than the bit rate.

### BACKGROUND OF THE INVENTION

1. Field of the Invention

The present invention relates to a network equipment which can measure a data transfer rate of a contents data distributed from a server.

2. Description of the Related Art

Recently, a system for sharing contents by using a home network such as DLNA (Digital Living Network Alliance) becomes widespread. This system enables a player which is connected to LAN (Local Area Network) and wireless communication to regenerate contents recorded in a server equipment such as a PC (Personal Computer) and HDD-Recorder (Hard Disk Drive-Recorder).

When the player regenerates the contents received from the server, a jumpiness of a frame and sound, a noise, and so on often occur and prevent a smooth regeneration. When such a trouble occurs, a complaint is raised by some user, and in that case, the cause for the trouble needs to be identified. However, various factors including a home network environment, a data transfer rate, and a bit rate of a video file, for example, are related to the cause of the trouble, so that it is often difficult to identify the cause.

Japanese Laid-Open Patent Publication No. 2004-146977 discloses a wireless digital communication system which changes a communication rate of data transmitted from a first communication unit to a second communication unit in accordance with an accumulation amount of the data in a buffer in the second communication unit. However, this system does not identify the cause of the above trouble, so that it cannot resolve the above problem.

Japanese Laid-Open Patent Publication No. 2005-33732 discloses a signal processor which determines the number of skipped frames and regenerated frames dynamically by using at least one of a bit rate of stream, a stream consumption rate during a high-speed regeneration of a video, and an input transfer rate of stream. However, this processor also cannot resolve the above problem.

Japanese Laid-Open Patent Publication Hei 10-336626 discloses a image data transfer device which measures a data transfer rate from a server by using a test data and requires a change of a bit rate of the transfer data in accordance with an accumulation amount of the data in a client buffer. Moreover, Japanese Laid-Open Patent Publication No. 2001-100924 discloses a record and regeneration system which measures a data transfer rate using a test data transferred from a host computer and reports to the host computer that the data cannot be recorded when determining that the data transfer rate is slower than a recording rate. However, these types of device and system use the test data to measure the data transfer rate, and there is a case that the data transfer rate measured by using the test data is different from the data transfer rate of contents which are received actually, so that they also cannot resolve the above problem.

### SUMMARY OF THE INVENTION

The present invention is to solve the problem described above, and an object of the present invention is to provide a network equipment which can inform a user whether or not a data transfer rate is fast enough (faster than or equal to a bit rate of the contents data) when receiving contents.

According to a first aspect of the present invention, this object is achieved by a network equipment, which is connected to a server in which a contents data having a bit rate parameter is recorded via a network, comprising: a receiving means to receive the contents data from the server via the network; a notification means to inform a user of various messages; a control means to control respective units in the equipment; a data transfer rate measuring means to measure a data transfer rate of the contents data which is currently received from the server by using the receiving means; and a data transfer rate comparison means to compare the data transfer rate which is measured by the data transfer rate measuring means with a bit rate of the contents data.

The control means measures the data transfer rate of the contents data which is currently received by the receiving means a predetermined number of times by using the data transfer rate measuring means, and subsequently calculates an average value of the measured data transfer rate to determine a current data transfer rate.

The control means compares the current data transfer rate with the bit rate of the contents data which is currently received by the receiving means by using the data transfer rate comparison means, and informs the user of a warning message which indicates that the current data transfer rate is not fast enough by using the notification means when the current data transfer rate is slower than the bit rate.

In the above configuration, the network equipment according to the present invention measures the data transfer rate the predetermined number of times during receiving the contents data and subsequently calculates the average value of the measured data transfer rate to determine the current data transfer rate. Then, the network equipment compares the current data transfer rate with the bit rate of the currently received contents data, and informs the user of a warning message which indicates that the current data transfer rate is not fast enough when the current data transfer rate is slower than the bit rate. Consequently, when the jumpiness of the frame and so on occur during the regeneration of the contents, the network equipment can easily determine whether or not they are caused by the slow data transfer rate, and inform the user that the data transfer rate is not fast enough, and thereby is user-friendly.

Moreover, unlike the conventional equipment, the network equipment according to the present invention measures the data transfer rate of the currently received contents data to regenerate the contents actually, without using the test data, so that when the jumpiness of the frame and so on occur during the regeneration of the contents, the network equipment can easily determine whether or not they are caused by the (slow) data transfer rate. Moreover, the current data transfer rate is determined by calculating the average value after measuring the data transfer rate the predetermined number of times, so that the variation in the calculated current data transfer rate can be avoided, and thus the highly reliable data transfer rate can be measured.

The above network equipment may further includes a light emitting means which is controlled by the notification means, wherein the control means compares the current data transfer rate with the bit rate of the contents data which is currently received by the receiving means by using the data transfer rate comparison means, and informs the user that the current data transfer rate is not fast enough by making the light emitting means emit a light by using the notification means when the current data transfer rate is slower than the bit rate.

According to a second aspect of the present invention, this object is achieved by a method of informing a user of a warning message, which indicates that the current data transfer rate is not fast enough, by using a network equipment which is connected via a network to a server in which a contents data is recorded, which comprises steps of: measuring a data transfer rate of a contents data which is currently received a predetermined number of times when receiving the contents data from the server via the network; calculating an average value of the measured data transfer rate to determine a current data transfer rate; comparing the current data transfer rate with a bit rate of the currently received contents data; and informing a user of a warning message which indicates that the current data transfer rate is not fast enough when the current data transfer rate is slower than the bit rate.

### BRIEF DESCRIPTION OF THE DRAWINGS

The present invention will be described below with reference to the annexed drawings. It is to be noted that all the drawings are shown for the purpose of illustrating the technical concept of the present invention or embodiments thereof, wherein:

FIG. 1 is a schematic configuration showing a network system which includes a network player according to a preferred embodiment of the present invention and a server connected to the network player;

FIG. 2 is a block diagram showing an internal configuration of the server in FIG. 1;

FIG. 3 is a block diagram showing an internal configuration of the network player in FIG. 1;

FIG. 4 is a flow chart showing steps of a contents receiving process in the network player in FIG. 1;

FIGS. 5A and 5B are illustration diagrams for describing a measuring process of a data transfer rate in the network player in FIG. 1;

FIGS. 6A to 6C are another illustration diagrams for describing the measuring process of the data transfer rate in the network player in FIG. 1;

FIG. 7 is a flow chart showing steps of a comparison process of the data transfer rate and a bit rate and a notification process in the network player in FIG. 1; and

FIG. 8 is a flow chart showing another steps of the comparison process of the data transfer rate and the bit rate and the notification process in the network player in FIG. 1.

### DESCRIPTION OF THE PREFERRED EMBODIMENTS

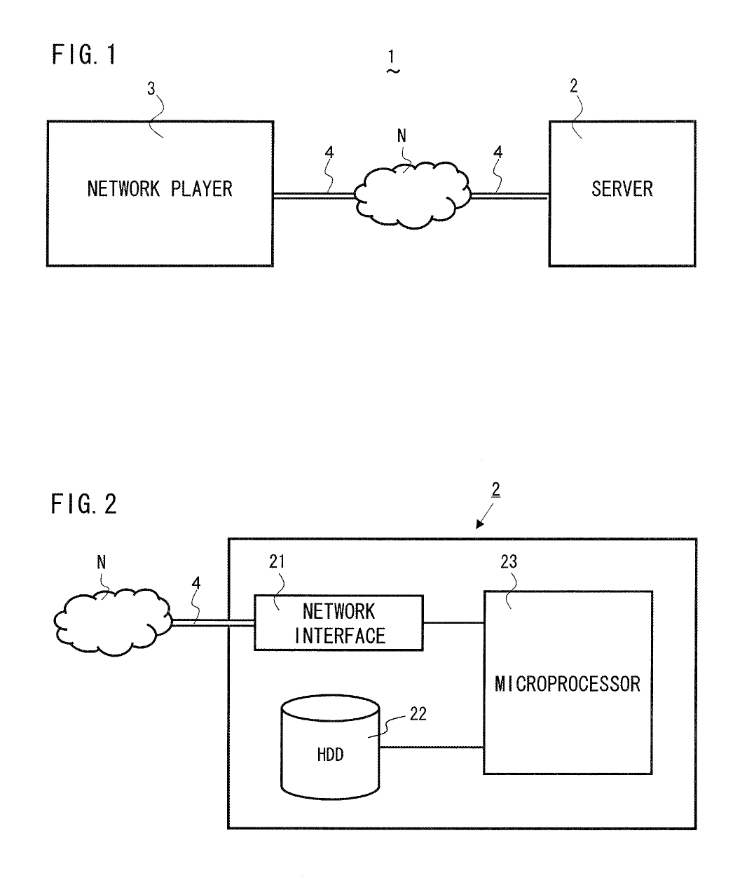

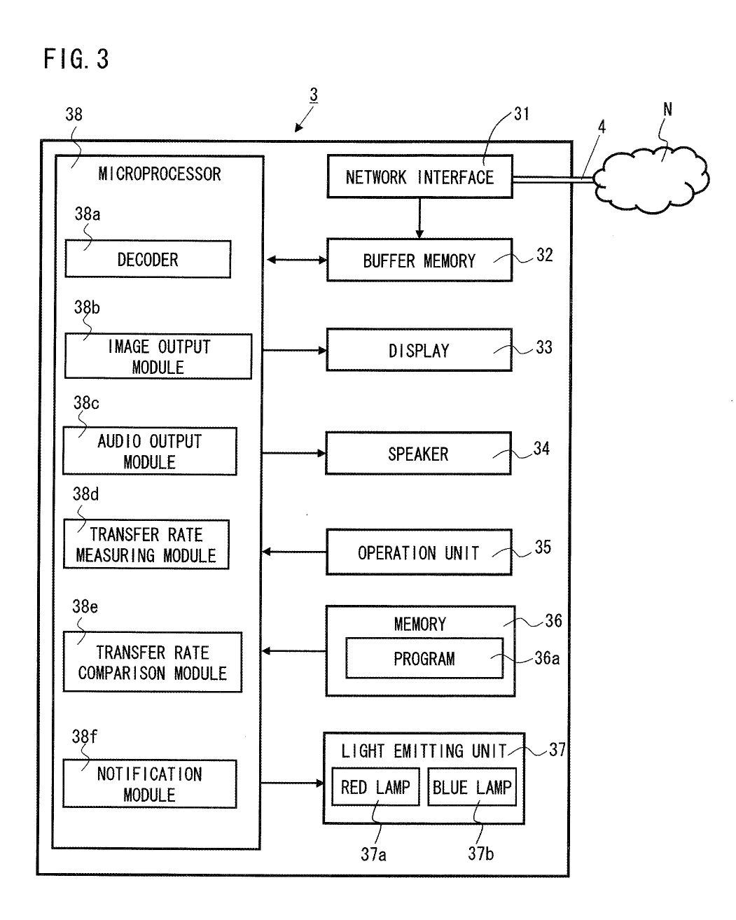

A network player according to a preferred embodiment of the present invention is described with reference to FIGS. 1 to 3. FIG. 1 shows a schematic configuration of a network system 1 including a network player (player) 3 and a server 2 which is connected to the network player 3 via a network N. FIG. 2 shows an internal configuration of the server 2, and FIG. 3 shows an internal configuration of the network player 3.

The server 2, which records plural contents, is an equipment which can distribute the contents via the network N. The network player 3, which includes a display 33 and a speaker 34, is an equipment which can regenerate the contents received via the network N. The network N is made up of Internet or a home network.

As shown in FIG. 2, the server 2 includes a network interface 21 to which a LAN (Local Area Network) cable 4 is connected so that the network interface 21 is connected to the network N, a hard disk (abbreviated as the HDD hereinafter) 22 which records the plural contents, and a microprocessor 23 which controls the respective units in the equipment. The server 2 distributes data of the appropriate contents to the network player 3 via the network interface 21 in accordance with a contents distribution requirement received from the network player 3.

The HDD 22 records the contents made up of a video file and an audio file. A header of the contents data records a parameter of a bit rate of the contents.

As shown in FIG. 3, the network player 3 includes a network interface (receiving means) 31 which is connected to the network N, a buffer memory 32 which temporarily stores the data, a display 33 which displays an image of the contents and so on, a speaker 34 which outputs an audio of the contents and so on, and an operation unit 35 which has a button and so on operated by a user. The network player 3 further includes a memory 36 which records various data, a light emitting unit (light emitting means) 37, and a microprocessor (control means) 38 which controls the respective units in the equipment.

The buffer memory 32 temporarily stores the data of the contents received from the server 2 via the network interface 31. The memory 36 stores a program 36a to make the microprocessor 38 work.

The light emitting unit 37 has a red lamp 37a and a blue lamp 37b. A lighting-up of the red lamp 37a and blue lamp 37b is controlled by a notification module 38f described below. The user is informed of various warning messages by the red lamp 37a and the blue lamp 37b turned on and off.

The microprocessor 38 has a decoder 38a, an image output module 38b, an audio output module 38c, a transfer rate measuring module (data transfer rate measuring means) 38d, a transfer rate comparison module (data transfer rate comparison means) 38e, and the notification module (notification means) 38f. The microprocessor 38 requires the distribution of the contents specified by the user to the server 2, for example. Moreover, the microprocessor 38 obtains the bit rate parameter of the received contents from the header information of the contents.

The decoder 38a takes out the contents data stored in the buffer memory 32 and performs a decoding processing on the contents data to extract image signals and audio signals of the contents. The contents data is taken out when a predetermined data amount is accumulated in the buffer memory 32, for example.

The image output module 38b outputs an image based on the image signals extracted by the decoder 38a and various messages to the display 33. The audio output module 38c outputs an audio based on the audio signals extracted by the decoder 38a to the speaker 34.

The transfer rate measuring module 38d measures the data transfer rate of the contents data which is currently received from the server 2 via the network interface 31. The specific measuring method is described below.

The transfer rate comparison module 38e compares the data transfer rate measured by the transfer rate measuring module 38d with the bit rate of the contents which is currently received from the server 2 via the network interface 31.

The notification module 38f informs the user of the various messages by displaying a message on the display 33 and controlling the lighting of the red lamp 37a and the blue lamp 37b in the light emitting unit 37.

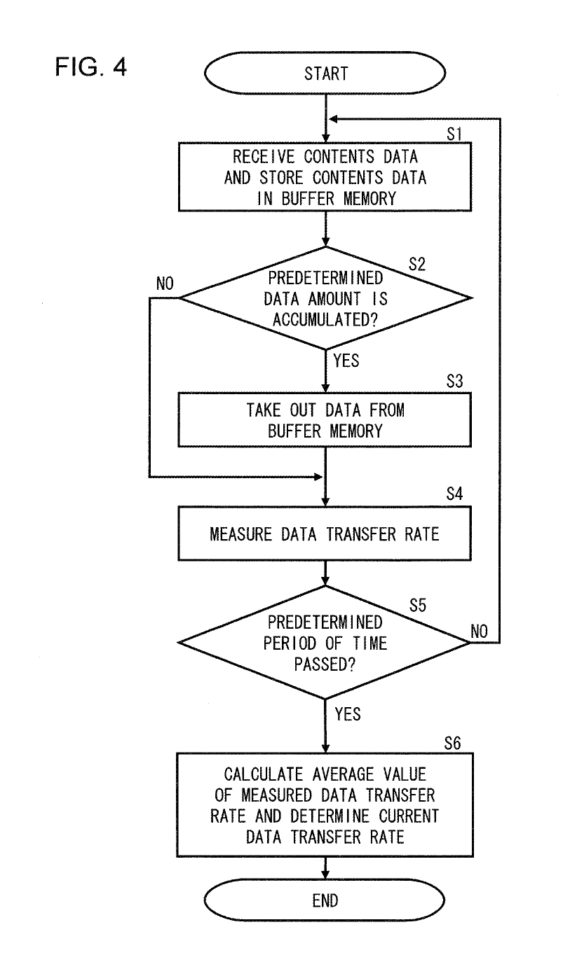

Next, steps of the contents receiving process in the network player 3 is described with reference to a flow chart in FIG. 4. At this time, the content is currently received from the server 2.

The microprocessor 38 firstly makes the buffer memory 32 store the contents data which is currently received via the network interface 31 (S1), and when the predetermined data amount is accumulated in the buffer memory 32 (YES in S2), the microprocessor 38 takes out the data from the buffer memory 32 and transmits it to the decoder 38a (S3). In contrast, when the predetermined amount of data is not accumulated in the buffer memory 32 (NO in S2), the microprocessor 38 does not perform the above step of S3.

Subsequently, the microprocessor 38 measures the data transfer rate of the currently received contents data by using the transfer rate measuring module 38d (S4) and repeats the processing of the above S1 to S4 several times until a predetermined period of time passes (NO in S5).

After the predetermined period of time (YES in S5), the microprocessor 38 determines the current data transfer rate by calculating an average value of the plural data transfer rates measured in the predetermined period of time (S6).

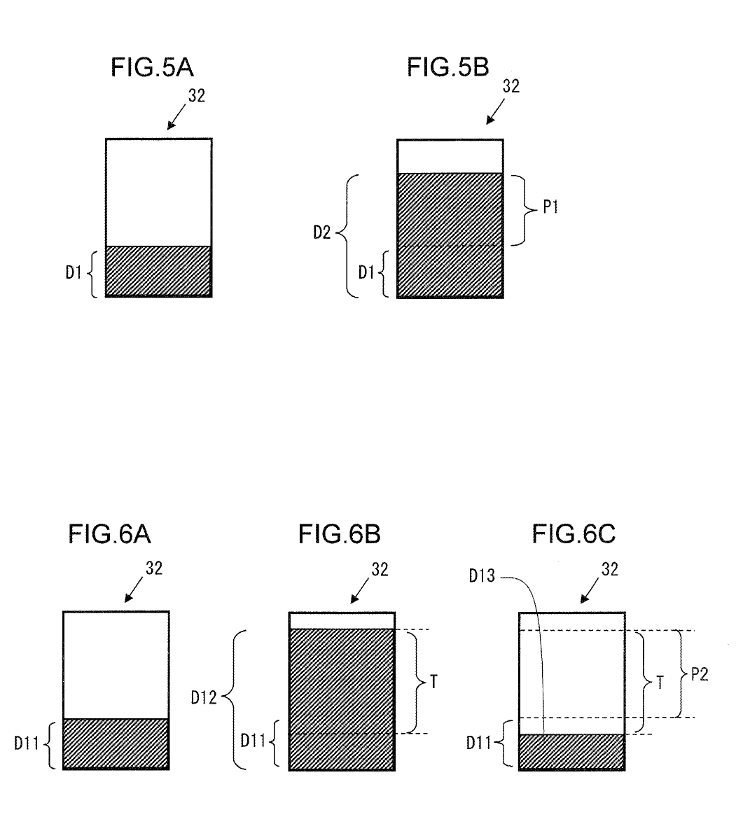

Next, the measuring method of the data transfer rate in the above S4 is described with reference to FIGS. 5A, 5B, 6A, 613, and 6C. FIGS. 5A to 6C are concept diagrams showing amounts of data stored in the buffer memory 32, respectively.

Supposing that at some point the buffer memory 32 stores the data amounting to D1 as shown in FIG. 5A, and that after the predetermined period of time the buffer memory 32 stores the data amounting to D2 as shown in FIG. 5B, the transfer rate measuring module 38d calculates an increased data amount P1 per the predetermined period of time by subtracting the data amount D1 from the data amount D2. Then, the transfer rate measuring module 38d calculates the data transfer rate per unit of time in accordance with the increased data amount P1, that is 5 Mbps, for example.

Supposing that at some point the buffer memory 32 stores the data amounting to D11 as shown in FIG. 6A, that subsequently at another point forward in time the buffer memory 32 stores the data amounting to D12 as shown in FIG. 6B, that then the decoder 38a takes out the data amounting to T as shown in FIG. 6C, and that after a predetermined period of time from the some point the buffer memory 32 stores the data amounting to D13 as shown in FIG. 6C, the transfer rate measuring module 38d calculates an increased data amount P2 per the predetermined period of time by subtracting the data amount D11 from the total of the current data amount D13 and the data amount T. Then, the transfer rate measuring module 38d calculates the data transfer rate per unit of time in accordance with the increased data amount P2.

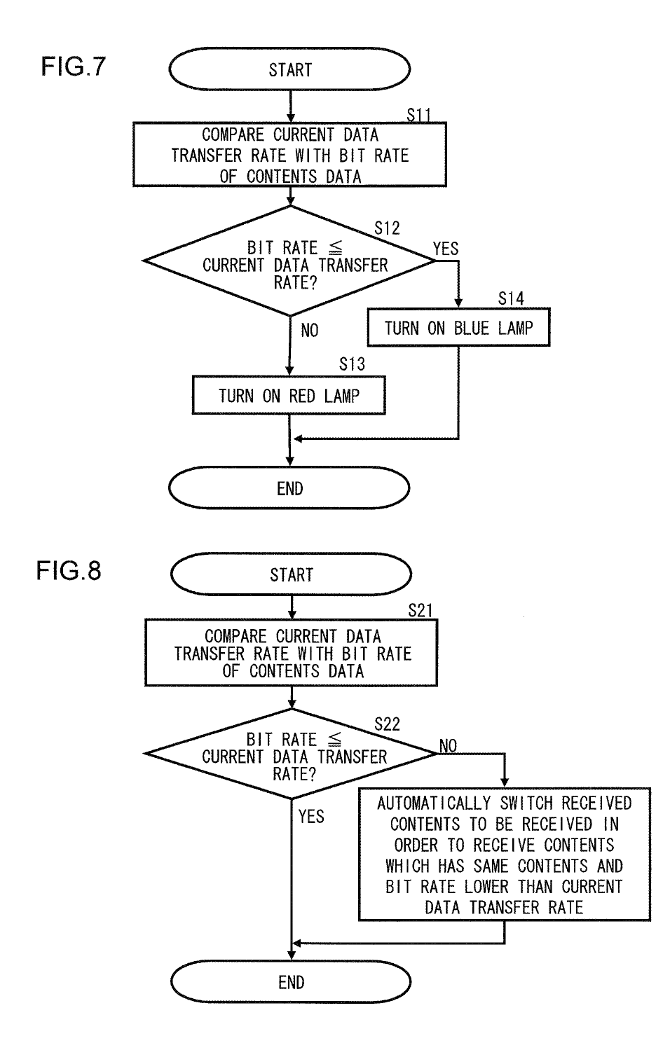

Next, an example of the comparison process of the current data transfer rate and a bit rate of the contents and a notification process is described with reference to a flow chart in FIG. 7. At this time, suppose that the current data transfer rate is already measured via the process in the above FIGS. 5A and 5B.

The microprocessor 38 firstly compares the current data transfer rate with the bit rate of the contents data which is currently received via the network interface 31 by using the transfer rate comparison module 38e (S11), and when the current data transfer rate is equal to or faster than the bit rate of the currently received contents data (YES in S12), the microprocessor 38 turns on the blue lamp 37b (S14). In contrast, when the current data transfer rate is slower than the bit rate of the currently received contents data (NO in S12), the microprocessor 38 turns on the red lamp 37a (S14).

Next, another example of the comparison process of the current data transfer rate and the bit rate of the contents and the notification process is described with reference to a flow chart in FIG. 8. At this time, suppose that the current data transfer rate has already been measured via the process in the above FIGS. 5A and 5B, and moreover, the contents which have the same contents and different bit rates are recorded in the HDD 22 of the server 2.

The microprocessor 38 compares the current data transfer rate with the bit rate of the contents data which is currently received via the network interface 31 by using the transfer rate comparison module 38e (S21), and when the current data transfer rate is slower than the bit rate of the currently received contents data (NO in S22), the microprocessor 38 switches automatically the contents to be received in order to receive the contents which have the same content and the bit rate lower than the currently received bit rate from the server 2 (S23). In contrast, when the current data transfer rate is equal to or faster than the bit rate of the currently received contents data (YES in S22), the microprocessor 38 does not perform the above process of S23.

As described above, the network player 3 according to the present preferred embodiment measures the data transfer rate the predetermined number of times during receiving the contents data, and subsequently calculates the average value of the measured data transfer rate to determine the current data transfer rate. Then, the network player 3 compares the current data transfer rate with the bit rate of the currently received contents data and informs the user of a warning message which indicates that the current data transfer rate is not fast enough by turning on the red lamp 37a when the current data transfer rate is slower than the bit rate. Consequently, when the jumpiness of the frame and so on occur during the regeneration of the contents, the network player 3 can easily determine whether or not they are caused by the slow data transfer rate and inform the user that the data transfer rate is not fast enough, and thereby is user-friendly.

Moreover, when the current data transfer rate is slower than the bit rate of the currently received contents data, the network player 3 can switch automatically the contents to be received in order to receive the contents which have the same content and the bit rate lower than the bit rate of the currently received contents, and thereby is user-friendly.

Furthermore, unlike the conventional equipment, the network player 3 measures the data transfer rate of the currently received contents data to regenerate the contents data actually without using the test data, so that when the jumpiness of the frame and so on occur during the regeneration of the contents, the network player 3 can easily determine whether or not they are caused by the slow current data transfer rate. Moreover, the current data transfer rate is determined by calculating the average value after measuring the data transfer rate the predetermined number of times, so that the variation in the calculated current data transfer, rate can be avoided, and thus the highly reliable data transfer rate can be measured.

The present invention is not limited to the configuration of the above preferred embodiment, however, various modification are applicable within the scope of the invention. For example, in the above preferred embodiment, when the current data transfer rate is lower than the bit rate, the red lamp 37a is turned on, however, it is also applicable to inform the user by displaying a message of “the data transfer rate is not fast enough”, for example, on the display 33.

What is claimed is:

1. A network equipment which is connected to a server, in which a contents data having a bit rate parameter is recorded, via a network, comprising:
a receiving means to receive the contents data from the server via the network;
a notification means to inform a user of various messages;
a control means to control respective units in the equipment;
a data transfer rate measuring means to measure a data transfer rate of the contents data which is currently received from the server by using the receiving means; and
a data transfer rate comparison means to compare the data transfer rate which is measured by the data transfer rate measuring means with a bit rate of the contents data, wherein
the control means measures the data transfer rate of the contents data which is currently received by the receiving means a predetermined number of times by using the data transfer rate measuring means, and subsequently calculates an average value of the measured data transfer rate to determine a current data transfer rate and wherein
the control means compares the current data transfer rate with the bit rate of the contents data which is currently received by the receiving means by using the data transfer rate comparison means, and informs the user of a warning message which indicates that the current data transfer rate is not fast enough by using the notification means when the current data transfer rate is slower than the bit rate.

2. The network equipment according to claim 1 further comprising:
a light emitting means which is controlled by the notification means, wherein
the control means compares the current data transfer rate with the bit rate of the contents data which is currently received by the receiving means by using the data transfer rate comparison means, and informs the user that the current data transfer rate is not fast enough by making the light emitting means emit a light by using the notification means when the current data transfer rate is slower than the bit rate.

3. The method of informing a user of a warning message, which indicates that the current data transfer rate is not fast enough, by using a network equipment which is connected via a network to a server in which a contents data is recorded, which comprises steps of:
measuring a data transfer rate of a contents data which is currently received a predetermined number of times when receiving the contents data from the server via the network;
calculating an average value of the measured data transfer rate to determine a current data transfer rate;
comparing the current data transfer rate with a bit rate of the currently received contents data; and
informing a user of a warning message which indicates that the current data transfer rate is not fast enough when the current data transfer rate is slower than the bit rate.

4. The method according to claim 3, wherein
the user is informed of the warning message which indicates that the current data transfer rate is not fast enough by a lamp turned on.
